(19) United States
(12) Patent Application Publication
(10) Pub. No.: US 2007/0163077 A1
(43) Pub. Date: Jul. 19, 2007

(54) UNIVERSAL MAGNETIC DOOR STOPPER WITH AN AIR BUFFERING STRUCTURE

(76) Inventors: Jun-Jie Yang, Homei Town (TW); Jinn-Yi Deng, Huatan Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/306,992

(22) Filed: Jan. 18, 2006

(51) Int. Cl. E05F 5/06

(52) U.S. Cl. 16/85

(57) ABSTRACT

A universal magnetic door stopper with an air buffering structure comprises a stopping assembly fixed on a wall and an adsorber fixed on a door panel. The stopping assembly includes a base, an air cylinder, a support piece, a screw and a washer. The adsorber includes a powerful magnet, a bush, an elastic member, a screw and a washer. By such arrangements, the air cylinder of the stopping assembly will cooperate with the elastic member of the adsorber to provide a buffering effect, and the universal pivoting feature of magnet will maintain a surface contact relation between the adsorber and the stopping assembly, so that they can be attracted to each other firmly.

### BACKGROUND OF THE INVENTION

1. Field of the Invention

The present invention relates to a door stopper, and more particularly to a universal magnetic door stopper with an air buffering structure, which can provide a good buffering effect when the adsorber contacts the wall after the door panel is opened, and can enable the door panel to be positioned more firmly.

2. Description of the Prior Art

A door stopper is disposed between a door panel and a wall for preventing the door panel or the handle on the door panel from impacting the wall when opening or closing a door. The door stopper also can position the door panel, preventing it from shaking after the door is opened. Therefore, most of the existing door panels are equipped with door stopper structure.

As shown in FIGS. 1 and 2, a commonly seen door stopper structure is illustrated and comprises a shaft 10 and an adsorber 20. The shaft 10 is fixed at a predetermined position on a wall 30. A base 101 is formed at the end of the shaft 10, a column 102 extends from the center of the base 101, and a spherical head 103 is formed at the front end of the column 102. A magnetic member 104 is inserted in the spherical head 103 and partially protrudes therefrom. The adsorber 20 is fixed at a corresponding position on the back surface of the door panel 40. A base 201 is formed at the adsorber 20, a cylinder 202 is formed at the center of the base 201, and a nested iron-made element is embedded in the cylinder 202. When the door pane 40 is opened, the nested element 203 of the adsorber 20 will be adsorbed on the magnetic member 104 of the spherical head 103 of the shaft 10, thus holding the door 40 at the opening position.

This conventional door stopper structure has the following shortcomings that need to be improved:

1, when the door panel 40 is opened, and the nested element 203 of the adsorber 20 is adsorbed on the magnetic member 104 of the spherical head 103 of the shaft 10, the instant impact between two hard objects will produce an unpleasing noise.

2, when the wall 30 is parallel to the door panel 40, the spherical head 103 of the shaft 10 will be likely to have a point contact or line contact with the nested element 203 of the adsorber 20, the adsorbing effect therebetween will not be good, and they will be disengaged easily by wind or a slight impact.

3, when the nested element 203 of the adsorber 20 is adsorbed on the magnetic member 104 of the spherical head 103 of the shaft 10, a considerable impact force will be generated. Therefore, the magnetic member 104 is liable to be broken after a certain time of use.

The present invention has arisen to mitigate and/or obviate the afore-described disadvantages.

### SUMMARY OF THE INVENTION

A universal magnetic door stopper with an air buffering structure provided by the present invention comprises a stopping assembly fixed on a wall and an adsorber fixed on a door panel. The stopping assembly includes a base, an air cylinder, a support piece, a screw and a washer. A through hole is formed in the center of the base, and a recess is defined in the top surface of the base. An end of the air cylinder is defined with an opening, and another end of the air cylinder is formed a closed surface. A connecting edge is formed around the outer periphery of the closed surface for engaging with the recess of the base. A hole is defined in the center of the closed surface, and a sleeve is arranged in the air cylinder and extends from the closed surface. The periphery of the air cylinder and sleeve are formed with an air slot, respectively. The support piece is made of iron, an engaging column having an engaging hole extends from the center of the support piece, and an inner annular groove and an outer annular groove are formed in the same side surface of the support piece as the engaging column. The screw is two-stepped and used to assemble the support piece and the air cylinder together and fix them at a predetermined position on a wall. The washer is received in a big section of the two-stepped hole and is to be pressed against a stepped portion of the two-stepped screw. The adsorber includes a powerful magnet, a bush, an elastic member, a screw and a washer. The magnet is a circular piece and has a bowl-shaped hole formed in the center thereof. The bush has a bowl shaped locking hole and is received in the bowl-shaped recess of the magnet, so that the magnet can pivot in universal direction. The elastic member is arranged between the magnet and door panel. A screw is employed to assemble the magnet, the bush and the elastic member together and to fix them at a corresponding position on the door panel. The washer is disposed between the elastic member of the adsorber and the door panel.

The primary objective of the present invention is to provide a universal magnetic door stopper with an air buffering structure, wherein the stopping assembly is equipped with the air cylinder having a certain elasticity, the adsorber is provided with the elastic member, such arrangement can provide a good buffering effect when the adsorber contacts the wall after the door panel is opened, preventing the occurrence of strong impact and unpleasing noise.

The secondary objective of the present invention is to provide a universal magnetic door stopper with an air buffering structure, when the wall is unparallel to the door panel, the universal pivoting feature of magnet will cooperate with the elastic member to maintain a surface contact relation between the adsorber and the stopping assembly, and they can be attracted to each other firmly without being disengaged easily by wind or a slight impact.

Another objective of the present invention is to provide a universal magnetic door stopper with an air buffering structure, the stopping assembly is equipped with the air cylinder having a certain elasticity, the adsorber is provided with the elastic member, such arrangement can provide a good buffering effect when the adsorber contacts the wall after the door panel is opened, preventing the magnet from being broken caused by a strong impact. Therefore, the present invention is relatively durable.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a conventional door stopper;

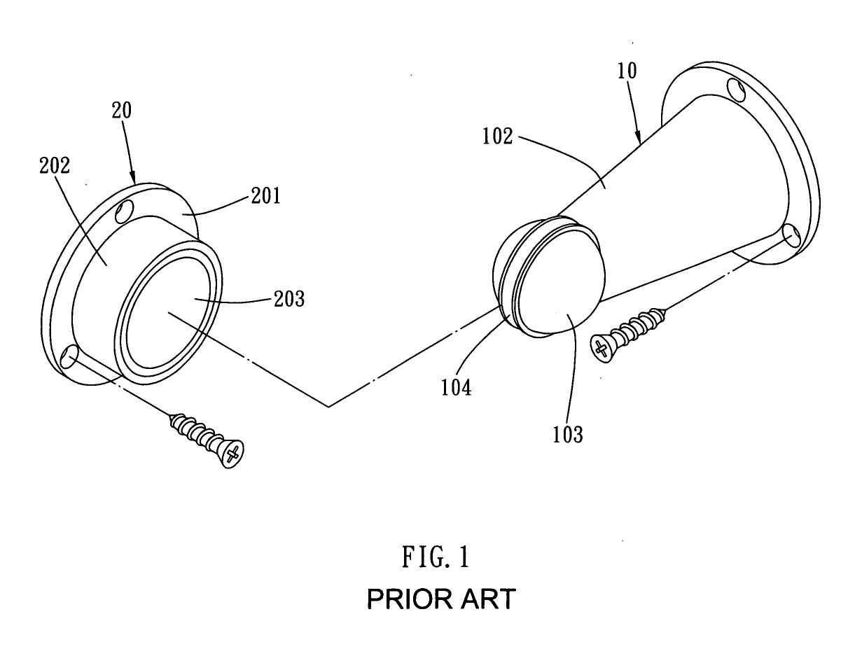

FIG. 2 is a cross sectional view of the conventional door stopper;

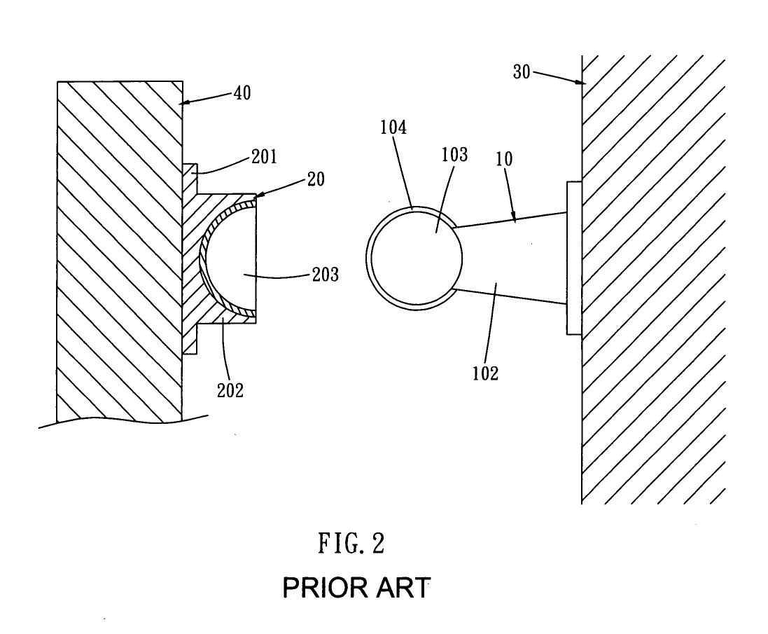

FIG. 3 is an exploded view of a door stopper in accordance with the present invention;

FIG. 4 is assembly view of the door stopper in accordance with the present invention;

FIG. 5 is a cross sectional view of the door stopper in accordance with the present invention;

FIG. 6 is an illustrative view of showing the generation of buffering effect of the door stopper in accordance with the present invention;

FIG. 7 is an illustrative view of showing that the door panel is being modified to a parallel position when it is unparallel to the wall; and

FIG. 8 is an illustrative view of showing that the adsorbing status of the present invention.

### DETAILED DESCRIPTION OF THE PREFERRED EMBODIMENTS

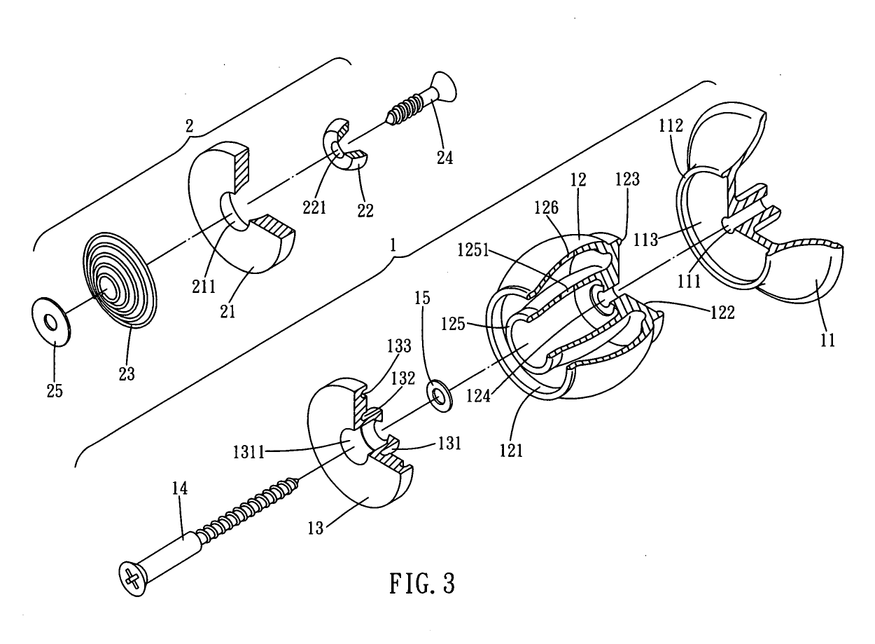

Referring to FIG. 3 firstly, a door stopper in accordance with a preferred embodiment of the present invention comprises a stopping assembly 1 and an adsorber 2. The stopping assembly 1 includes a base 11, an air cylinder 12, a support piece 13, a screw 14 and a washer 15. The base 11 is approximately square-shaped in cross section, a through hole 111 is formed in the center of the base 11, and an annular flange 112 is defined around the periphery of the top surface of the base 11. In the annular flange 112 is defined a recess 113. The air cylinder 12 is made of elastic material, an end of which is defined with an opening 121, and another end of which is formed a closed surface 112. A connecting edge 123 is formed around the outer periphery of the closed surface 112, a two-step hole 124 is defined in the center of the closed surface 112, and a sleeve 125 is arranged in the air cylinder 12 and extends from the closed surface 122. The periphery of the air cylinder 12 and sleeve 125 are formed with an air slot 126, 1251 respectively. The support piece 13 is made of iron, an engaging column 131 having an engaging hole 1311 extends from the center of the support piece 13, and an inner annular groove 132 and an outer annular groove 133 are formed in the same side surface of the support piece 13 as the engaging column 131. The screw 14 is two-stepped. The adsorber 2 includes a powerful magnet 2, a bush 22, an elastic member 23, a screw 24 and a washer 25. The magnet 21 is a circular piece and has a bowl-shaped hole formed in the center thereof. The bush 22 is bowl shaped, and the thickness of the bush 22 is slightly smaller than that of the hole 211 of the magnet 21. A locking hole 221 is formed in the bush 22. The elastic member 23 is a conical spring.

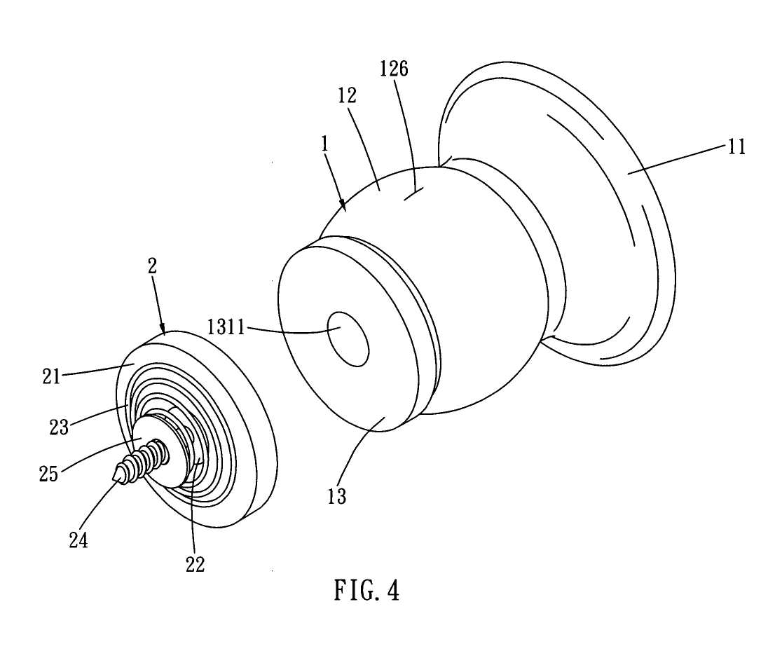

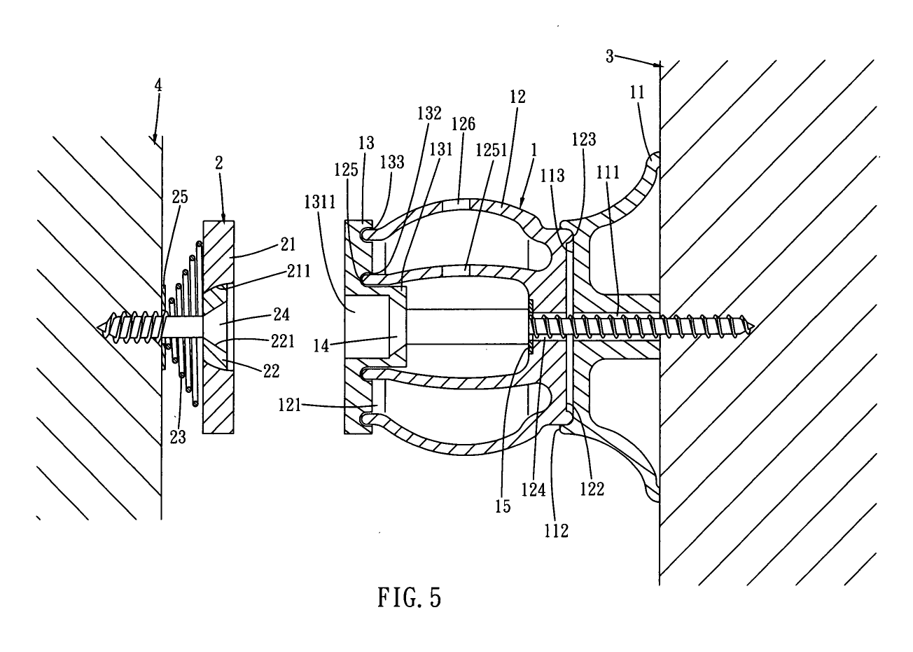

As shown in FIGS. 4 and 5, in assembly of the stopping assembly 1, the connecting edge 123 of the air cylinder 12 is inserted in the recess 1113 of the base 11 and pressed against the inner wall of the annular flange 112 of the base 10. The washer 15 is received in the big section of the two-stepped hole 124 of the air cylinder 12. The engaging column 131 of the support piece 13 is engaged in the sleeve 125 and abutted against the inner periphery thereof in such a manner that the inner and outer annular grooves 132 and 133 of the support piece 13 are engaged with the terminal edge of the air cylinder 12 and that of the sleeve 123. And then the screw 14 is screwed at the predetermined position in the wall 3 after passing through the engaging hole 1311 of the support piece 13, the central hole of the washer 15, the two-stepped hole 124 of the air cylinder 12, and the through hole 111 of the base 11. And the head of the screw 14 is locked in the engaging hole 1311 of the support piece 13, and the stepped portion of the screw 14 abuts against the washer 15, locking the base 11, the air cylinder 12 and the support piece 13 together and fixing them on the wall 3. In this way, the assembly of the stopping assembly 1 is finished. In assembly of the adsorber 2, the bush 22 is engaged in the bowl-shaped hole 211 of the magnet 21, and then the screw 24 is screwed at a corresponding position in the door panel 4 after passing through the locking hole 221 of the bush 22, the hole of the elastic member 23, and the central hole of the washer 25. The head of the screw 24 is engaged in the locking hole 221 of the bush 22. The magnet 21 will compress the elastic member 23 properly toward the direction of the washer 25, thus assembling the magnet 21, the sleeve 22 and the elastic member 23 together and fixing them on the door panel 4. In this way, the assembly of the adsorber 2 is finished.

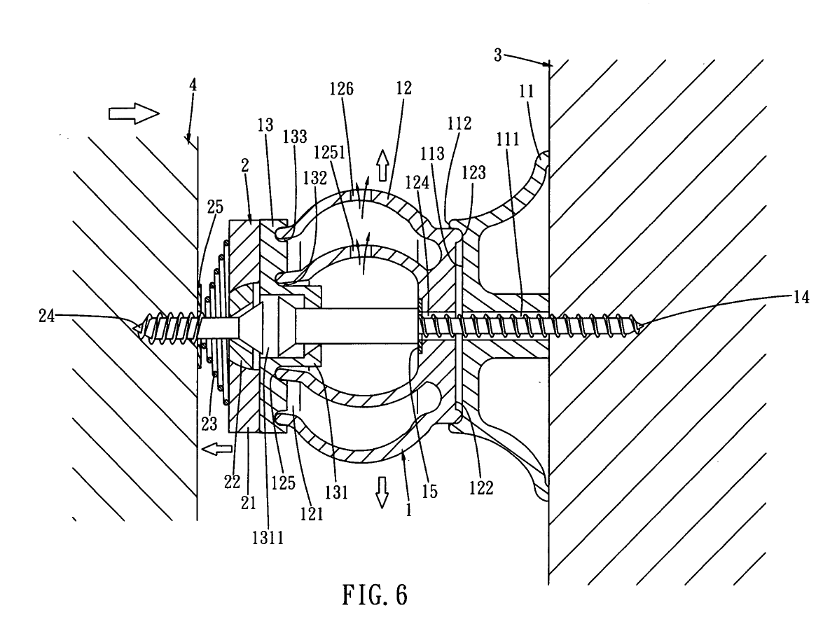

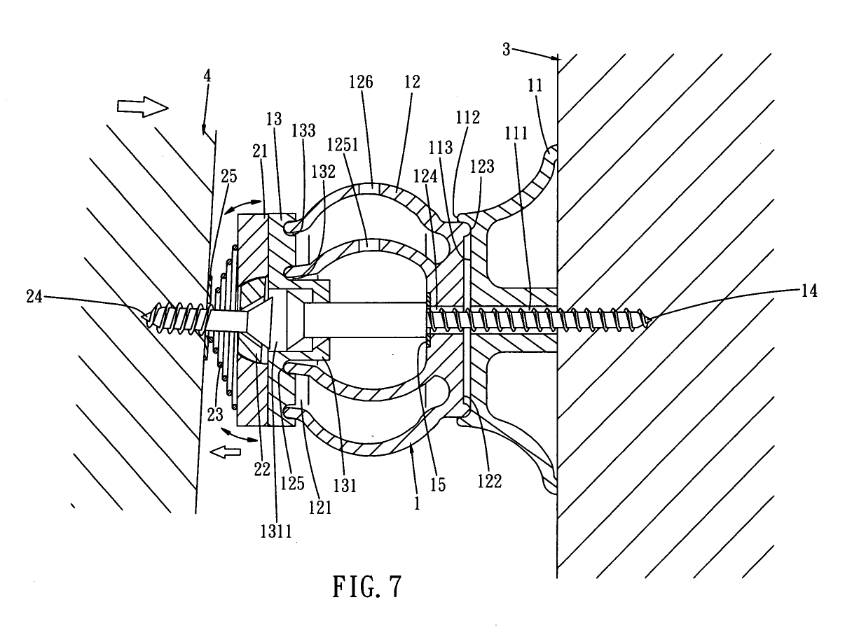

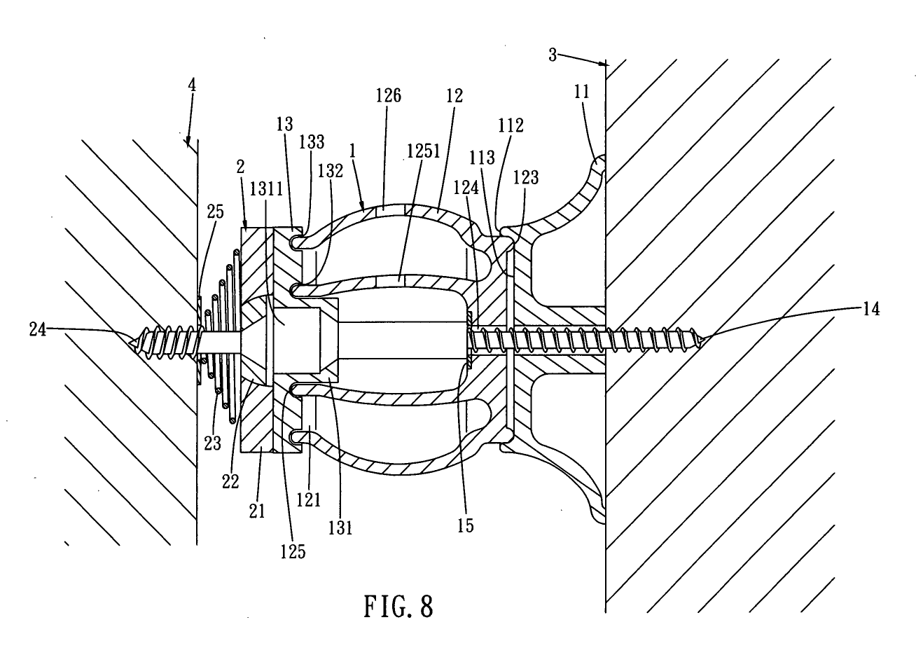

Referring then to FIGS. 6-8, when the door panel 4 is swung to open and positioned, and the magnet 21 contacts the support piece 13 of the stopping assembly 1, the air cylinder 12 and the elastic member 23 will be deformed instantly, and air will be discharged via the air slots 126, 1251, thus providing a buffering effect. At the same time, the bowl-shaped hole 211 of the magnet 21 can cooperate with the bush 22, creating a universal pivoting mechanism. And the universal pivoting mechanism will cooperate with the elastic member 23, whatever the wall 3 is parallel to the door panel 4 or not, so as to make the magnet 21 of the adsorber 2 have a surface contact with the support piece 13 of the stopping assembly 1, thus enabling the door panel 4 to be stably held at the open position.

It can be concluded from the abovementioned embodiment that the present invention has the following advantages:

1, the stopping assembly 1 is equipped with the air cylinder 12 having a certain elasticity, the adsorber 2 is provided with the elastic member 23, such arrangement can provide a good buffering effect when the adsorber 2 contacts the wall 3 after the door panel 4 is opened, preventing the occurrence of strong impact and unpleasing noise. Accordingly, the present invention has an improved practicability.

2, When the wall 3 is unparallel to the door panel 4, the universal pivoting feature of magnet 21 will cooperate with the elastic member 23 to maintain a surface contact relation between the adsorber 2 and the stopping assembly 1, and they can be attracted to each other firmly without being disengaged easily by wind or a slight impact.

3, the stopping assembly 1 is equipped with the air cylinder 12 having a certain elasticity, the adsorber 2 is provided with the elastic member 23, such arrangement can provide a good buffering effect when the adsorber 2 contacts the wall 3 after the door panel 4 is opened, preventing the magnet 21 from being broken caused by a strong impact. Therefore, the present invention is relatively durable.

While we have shown and described various embodiments in accordance with the present invention, it should be clear to those skilled in the art that further embodiments may be made without departing from the scope of the present invention.

What is claimed is:

1. A universal magnetic door stopper with an air buffering structure comprising a stopping assembly fixed on a wall and an adsorber fixed on a door panel, characterized in that:
the stopping assembly includes a base, an air cylinder mounted the base, an iron-made support piece mounted on the air cylinder, and a two-stepped screw used to assemble the support piece and the air cylinder together and fix them at a predetermined position on a wall;
the adsorber includes a magnet, a bowl-shaped hole formed in the center of the magnet for receiving a bush, an elastic member attached to a back surface of the magnet, and a screw employed to assemble the magnet, the bush and the elastic member together and to fix them at a corresponding position on the door panel in such a manner that the elastic member is arranged between the magnet and door panel, and the magnet can universally pivot.

2. The universal magnetic door stopper with an air buffering structure as claimed in claim 1, wherein the base is approximately square-shaped in cross section, a through hole is formed in a center of the base, an annular flange is defined around a periphery of a top surface of the base, and in the annular flange is defined a recess.

3. The universal magnetic door stopper with an air buffering structure as claimed in claim 1, wherein the air cylinder is made of elastic material, an end of which is defined with an opening, and another end of which is formed a closed surface, a connecting edge is formed around an outer periphery of the closed surface, a hole is defined in a center of the closed surface, and a sleeve is arranged in the air cylinder and extends from the closed surface.

4. The universal magnetic door stopper with an air buffering structure as claimed in claim 3, wherein the hole of the closed surface is two-stepped, and a washer is received in a big section of the two-stepped hole and is to be pressed against a stepped portion of the two-stepped screw.

5. The universal magnetic door stopper with an air buffering structure as claimed in claim 3, wherein a periphery of the air cylinder and sleeve are formed with an air slot, respectively.

6. The universal magnetic door stopper with an air buffering structure as claimed in claim 1, wherein an engaging column having an engaging hole extends from a center of the support piece, and an inner annular groove and an outer annular groove are formed in the same side surface of the support piece as the engaging column.

7. The universal magnetic door stopper with an air buffering structure as claimed in claim 1, wherein the bush of the adsorber is bowl shaped, and the thickness of the bush is slightly smaller than the thickness of the hole of the magnet, a locking hole is formed in the bush.

8. The universal magnetic door stopper with an air buffering structure as claimed in claim 1, wherein the elastic member is a conical spring.

9. The universal magnetic door stopper with an air buffering structure as claimed in claim 1, wherein a washer is disposed between the elastic member of the adsorber and the door panel.
